(19) United States
(12) Patent Application Publication
(10) Pub. No.: US 2017/0257001 A1
(43) Pub. Date: Sep. 7, 2017

(54) STATOR

(71) Applicant: AISIN SEIKI KABUSHIKI KAISHA, Kariya-shi, Aichi (JP)

(72) Inventors: Naoki KAMIYA, Anjo-shi, Aichi (JP); Akihiro ONO, Chita-gun, Aichi (JP)

(73) Assignee: AISIN SEIKI KABUSHIKI KAISHA, Kariya-shi, Aichi (JP)

(21) Appl. No.: 15/318,872

(22) PCT Filed: Sep. 18, 2015
(86) PCT No.: PCT/JP2015/076643

§ 371 Date: Dec. 14, 2016

(30) Foreign Application Priority Data
Oct. 14, 2014 (JP) 2014-209873

(51) Int. Cl. H02K 3/28; H02K 3/30; H02K 3/12

(52) U.S. Cl. CPC H02K 3/28; H02K 3/12; H02K 3/30

(57) ABSTRACT

A stator having good electric characteristics is reasonably configured. The stator includes a stator core including an annular core portion centered around a rotational axis of a rotor and a plurality of teeth portions protruding radially from the core portion, a core wire wound around the teeth portions, a resin plate to be superposed on the stator core along the rotational axis, the resin plate defining a hole therethrough along the rotational axis, into which hole an end portion of the coil wire is inserted, and a resin portion in which the stator core, the coil wire and the plate are embedded. The end of the coil wire is directly connected to a bus bar for electric power supply or grounding, with the end of the coil wire being exposed from the resin portion.

### TECHNICAL FIELD

The present invention relates to a stator of a rotating electrical machine, more particularly, to an end treatment of a coil wire wound around a stator core.

### BACKGROUND ART

As a conventional stator, there is known a stator including a stator core and a coil wire wound around the stator core, with an end of the coil wire being connected via a terminal member to a bus bar for electric power supply or grounding (see e.g. Patent Document 1).

In the stator disclosed in Patent Document 1, the stator core and the coil wire are insert-molded, with an end of the coil wire being inserted in a hole of a mold. In this, the document describes that in order to prevent leak of injected resin via a gap formed between the mold hole and the end of the coil wire, a predetermined sealing arrangement is provided on the side of the mold (paragraph [0079]). Next, as the end of the coil wire is brought into contact with the terminal member which is fixed to the bus bar, electric connection is established between the bus bar and the coil wire.

### CITATION LIST

Patent Document 1: Japanese Unexamined Patent Application Publication No. 2011-205875

### SUMMARY OF INVENTION

### Technical Problem

However, with the conventional stator, this requires an operation of inserting into the mold hole, with adjustment of the position of the end of the coil wire being effected concurrently. Thus, the assembly is troublesome. Further, the sealing arrangement provided in the mold may present an “obstacle”, which makes the insertion of the coil wire into the mold hole difficult. On the other hand, if such sealing arrangement were omitted, injected resin would leak to reach the position connected to the terminal member of the coil wire, thus forming burr, which may eventually inhibit or impair the electrical connection between the terminal member and the coil wire.

Further, in the conventional stator, the coil wire and the bus bar are connected via the terminal member, thus inviting increase of the number of components and/or deterioration in the electric characteristics due to increase of contact resistance between these components.

Then, there is a need for reasonably configuring a stator having good electric characteristics.

### SOLUTION TO PROBLEM

According to a characterizing feature of a stator relating to the present invention, the stator comprises: a stator core including an annular core portion centered around a rotational axis of a rotor and a plurality of teeth portions protruding radially from the core portion; a core wire wound around the teeth portions; a resin plate to be superposed on the stator core along the rotational axis, the resin plate defining a hole therethrough along the rotational axis, into which hole an end portion of the coil wire is inserted; and a resin portion in which the stator core, the coil wire and the plate are embedded; wherein the end of the coil wire is directly connected to a bus bar for electric power supply or grounding, with the end of the coil wire being exposed from the resin portion.

As described above, when the stator core is to be set to the mold, it is necessary to align the end of the core coil in position with the hole of the mold, while correcting shape/posture of the end of the coil wire, thus being troublesome. On the other hand, with the inventive arrangement above, it is possible to hold the end of the coil wire by inserting this end into the hole defined in the plate that lies over the stator core and extends along the rotational axis. As a result, when this end is to be inserted into the hole of the mold, the shape/posture of the coil wire can be stabilized. Therefore, the insertion of the coil wire into the mold hole can proceed smoothly, thus improving manufacture efficiency.

Further, with the above-described inventive arrangement, the end of the coil wire is directly connected to the bus bar, with this end being exposed from the resin portion. Thus, in comparison with an arrangement of connecting the coil wire and the bus bar via a terminal member, compactization is made possible with reduction in the number of components corresponding to omission of the terminal member. Moreover, as the arrangement eliminates a contact portion between the terminal member and the coil wire and/or a contact portion between the terminal member and the bus bar, it is possible to improve the electric characteristics with reduction of contact resistance.

In this way, by disposing the stator core, the coil and the plate in this order along the rotational axis and accommodating an end of the coil wire in the hole of plate extending along the rotational axis, it has become possible to rationally configure a stator having good electrical characteristics.

According to a further characterizing feature;

the plate includes a first plate and a second plate placed on the first plate;

the first plate defines a first groove portion configured to be connected to the hole of the first plate and to accommodate the coil wire; and

the hole of the second plate is communicated to the first groove portion.

With the above-described arrangement wherein the plate comprises two members and the first groove portion of the first plate is communicated to the respective holes of the first plate and the second plate, it becomes possible to offset the hole of the first plate and the hole of the second plate relative to each other as seen in the direction of the rotational axis. Therefore, resin entering the hole of the first plate will hardly reach the hole of the second plate via the first groove portion. Namely, as the resin exiting the hole of the first plate will encounter a drop of its pressure at the first groove portion, so that discharge of the resin from the hole of the second plate will hardly occur. Eventually, leak of injected resin to the hole of the mold in which the end portion of the coil wire is inserted will hardly occur, either. Consequently, it is possible to solve the inconvenience of formation of burr at the end of the coil wire, which would lead to deterioration of electrical characteristics.

According to a further characterizing feature, the second plate defines a second groove portion which is formed in opposition to the first groove portion and configured to accommodate the coil wire.

With the above-described arrangement of defining a second groove portion in the second plate also, it is possible to dispose the second plate on the first plate with fitting the coil wire exposed from the first groove portion within the second groove portion. Thus, attachment is facilitated.

According to a still further characterizing feature, the second plate includes a protruding portion which is inserted into the first groove portion, the protruding portion defining a second groove portion for accommodating the coil wire.

With the above arrangement of forming a protruding portion in the second plate and inserting this protruding portion in the first groove portion of the first plate, position-fixing of the second plate relative to the first plate can be carried out easily. Moreover, since the second groove portion in which the coil wire is accommodated is formed in the protruding portion constituting a position fixed portion, there is no need to provide a position fixing portion separately.

### BRIEF DESCRIPTION OF DRAWINGS

FIG. 1 is a section view of a water pump,

FIG. 2 is a section view of a stator core,

FIG. 3 is an exploded perspective view of the stator core and a plate,

FIG. 4 is a section showing a molded example of the stator,

FIG. 5 is a partial perspective view of the stator,

FIG. 6 is a partial perspective view of a plate according to Further Embodiment 1,

FIG. 7 is a section view showing a molded example of stator according to Further Embodiment 1,

FIG. 8 is a partial perspective view of a plate according to Further Embodiment 2, and

FIG. 9 is a partial perspective view of a plate according to Further Embodiment 3.

### DESCRIPTION OF EMBODIMENTS

Next, a stator relating to this embodiment will be explained with reference to the drawings. In this embodiment, as an example of stator, there will be explained a stator 4 of an electric motor M used in a water pump P for a vehicle configured to circulate cooling water. However, it should be noted that this invention is not limited to the following embodiment, but various modifications are possible in a range not departing from the essential spirit thereof.

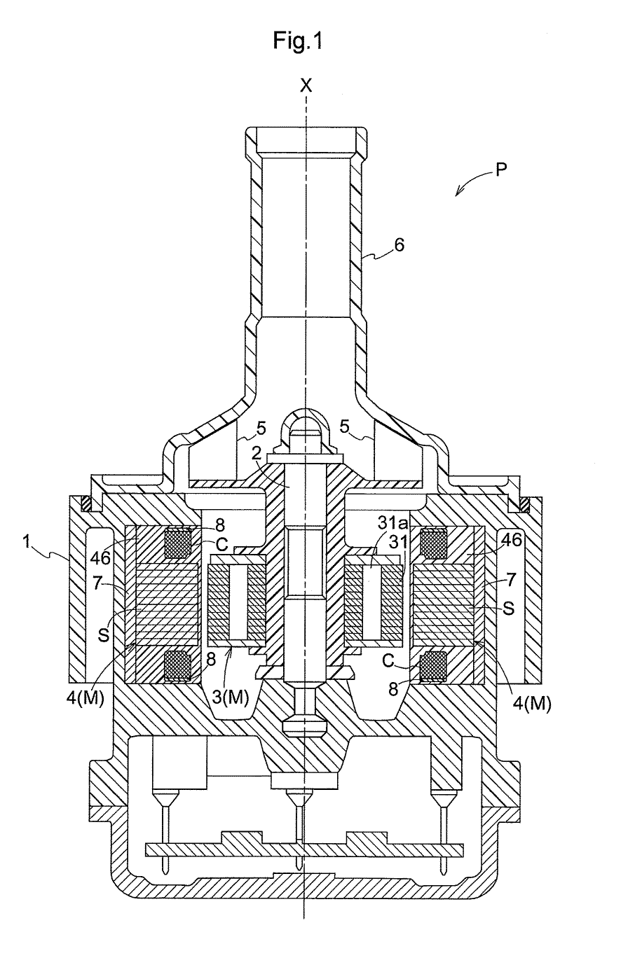

As shown in FIG. 1, the water pump P includes a resin casing 1, a support shaft 2 fixed to the casing 1, a cylindrical rotor 3 rotatable as being externally fitted on the support shaft 2, a cylindrical stator 4 disposed on the outer side of the rotor 3, and an impeller 5 fixed to one end of the rotor 3. As this impeller 5 is accommodated in a housing 6, there is constituted the water pump P configured to circulate cooling water to an inverter or circulating cooling water between an engine and a radiator.

The electric motor M for use in this water pump P comprises a three-phase brushless motor having the rotor 3 rotatable about a rotational axis X and the stator 4 for generating magnetic flux relative to the rotor 3. Incidentally, this electric motor M can be caused to function as a generator by rotating the rotor 3.

The rotor 3 includes a rotor core 31 formed by superposing a plurality of magnetic steel plates and a plurality of permanent magnets 31a embedded in the rotor core 31. The rotor core 31 and the permanent magnets 31a are insert-molded with resin and integrated with each other. The permanent magnets 31a are comprised of six magnetic poles, thus constituting the electric motor M having 6 poles, three phases, 9 throttles.

Incidentally, the permanent magnets 31a are not limited to six poles, but can be comprised of an even number of poles more than 2 (two) poles.

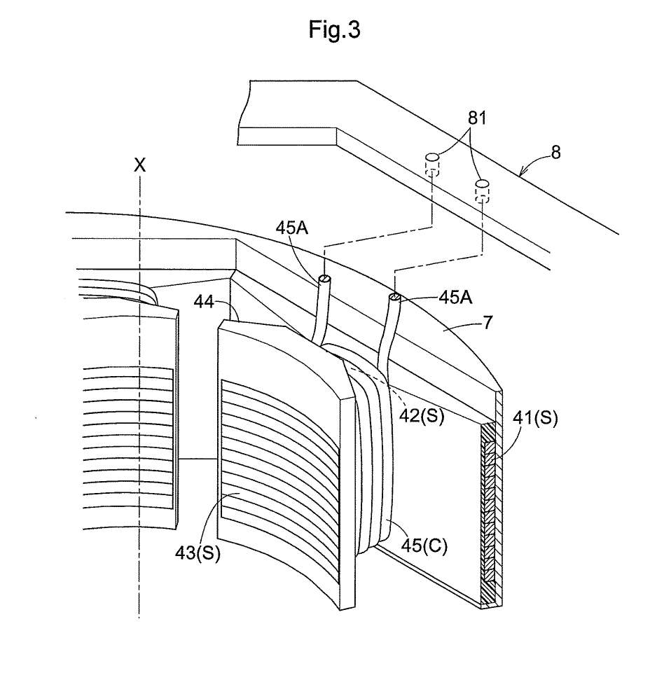

As shown in FIG. 3, the stator 4 includes a cylindrical stator core S, a resin insulator 44 encasing the stator core S, a coil C wound around a outer face of the insulator 44, and a cylindrical core case 7 holding the stator core S.

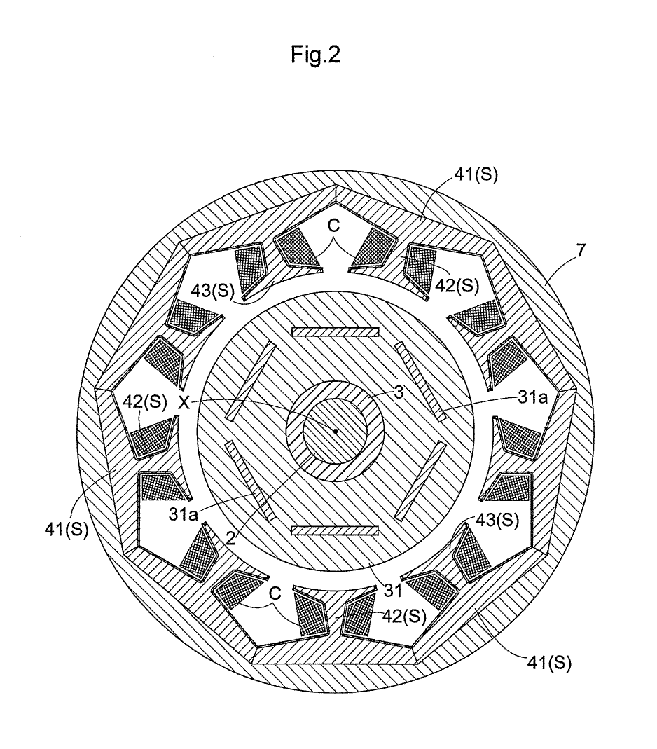

As shown in FIG. 2, the stator core S includes a core portion 41 formed in an annular region centering about a rotational axis X, a plurality of teeth portions 42 protruding from the core portion 41 in a radially inner direction, and flange portions 43 disposed along a circumferential direction about the rotational axis X at protruding ends of the plurality of teeth portions 42. This stator core S comprises split cores formed by forming a core member by laminating magnetic steel plates and then combing the plurality of such core members in an annular form. These split cores are held with their split faces being placed in contact with each other and the core case 7 being fitted externally thereon.

The respective teeth portions 42 extend radially (radial direction) around the rotational axis X and formed at 9 (nine) positions spaced apart from each other equidistantly along the circumferential direction. In the instant embodiment, the outer circumferential face of the core portion 41 comprises a nonagonal shape and the inner circumferential face of the core case 7 fitted along the outer circumferential face of this core portion 41 comprises also a nonagonal shape. Incidentally, the outer circumferential face of the core portion 41 and the inner circumferential face of the core case 7 are not limited to such polygonal shapes, but can be circular shape also, for instance.

As shown in FIG. 3, in the stator 4, with the resin insulator 44 being externally fitted on the stator core S, a coil wire 45 is wound around the teeth portion 42, thus forming a coil C. Though will be detailed later herein, the stator 4 with the coil C being wound is insert-molded with resin. The insulator 44 is provided for insulation between the stator core S and the coil C and covers at least the outer face of the teeth portion 42 and the inner faces of the core portion 41 and the flange portion 43. Also, in the coil wire 45, a resin such as polyurethane is coated on a surface of a copper wire having a round cross sectional shape. Incidentally, if appropriate insulation can be ensured between the stator core S and the coil C, the coil wire 45 may be directly wound around the teeth portion 42.

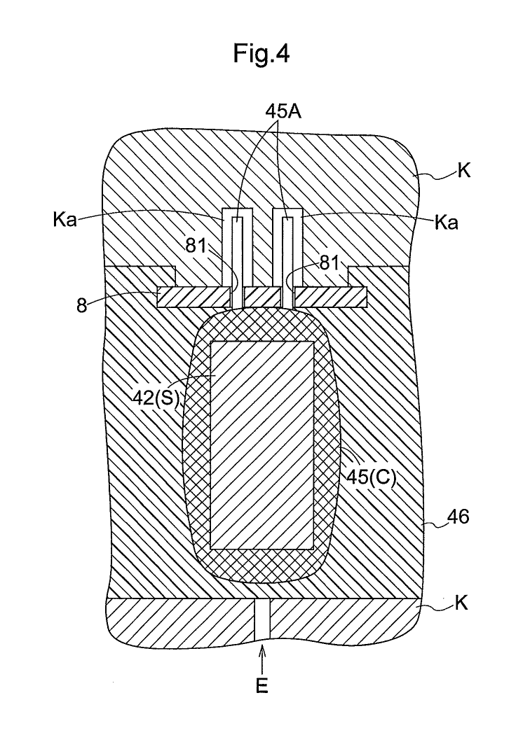

In the instant embodiment, as shown in FIG. 4, the stator 4 includes a resin portion 46 formed in the stator core S by injecting resin via an inlet E opposite to ends 45A of the coil wire 45 in the rotational axis X direction. A mold K for molding this resin portion 46 defines hole portions Ka into which the ends 45A of the coil wire 45 are to be inserted. As the inserting operation needs to be carried out with aligning the ends 45A of the coil wire 45 in position with the hole portions Ka, the assembly is troublesome.

Then, in the case of the stator 4 according to the instant embodiment, as shown in FIG. 3, there is provided a resin plate 8 that defines holes 81 for allowing insertion of the ends 45A of the coil wire 45 and that is to be superposed on the stator core S along the rotational axis X, with the holes 81 being formed through the plate 8 along the rotational axis X. This plate 8 is formed as a polygonal integral shape or split shapes as seen in the rotational axis X direction and is fixed in position as being placed in abutment against the inner circumferential face of the core case 7 and the outer circumferential face of the insulator 44 covering the flange portion 43. Incidentally, the manner of position-fixing of the plate 8 is not particularly limited. For instance, instead of the inner circumferential face of the core case 7, the insulator 44 covering the core portion 41 may be caused to protrude in the rotational axis X direction and the plate 8 may be placed in abutment against the inner circumferential face of this insulator 44. Further, the shape of the plate 8 is not particularly limited, but can be set appropriately in accordance with the shapes of the insulator 44 and the core case 7.

As described above, the plate 8 defines therethrough the holes 81 along the rotational axis X for allowing insertion of the ends 45A of the coil wire 45. Thus, as shown in FIG. 4, it is possible to insert the ends 45A into the hole portions Ka of the mold K smoothly, with maintaining the shape/posture of the ends 45A of the coil wire 45 in a stable manner. Then, when resin is injected via the inlet E, the stator core S, the coil wire 45 and the plate 8 will be insert-molded as being embedded in the resin portion 46.

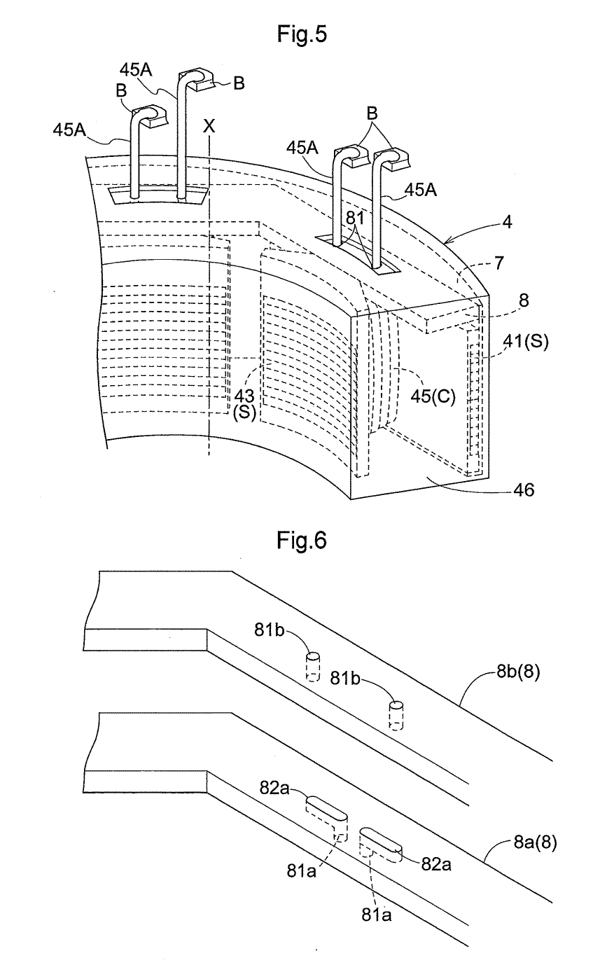

As shown in FIG. 5, in the insert-molded stator 4, the ends 45A of the coil wire 45 are exposed from the resin portion 46 and are directly connected to bus bars B for electric power supply or grounding incorporated in a substrate (not shown). Incidentally, the ends 45A of the coil wire 45 and the bus bars B will be electrically connected to each other by effecting fusing (thermal calking) or spot welding, etc.

Namely, the stator 4 according to the instant embodiment omits any terminal member for establishing electric connection between the coil wire 45 and the bus bar B.

On the other hand, such omission of terminal member results in greater trouble in inserting the ends 45A of the coil wire 45 into the hole portions Ka of the mold K. However, by providing the plate 8, the assembly can be facilitated. Moreover, since a contact portion between a terminal member and the coil wire 45 and a contact portion between the terminal member and the bus bar B are eliminated, contact resistance can be reduced, thus improving the electric characteristics.

Next, further embodiments will be explained. As basic configurations thereof are identical to that of the foregoing embodiment, only differences thereof will be explained with reference to the drawings. Incidentally, for readiness of understanding of drawing illustrations, in the following explanation, the same parts names and marks as those employed in the foregoing embodiment will be used in the following explanation.

### Further Embodiment 1

As shown in FIG. 6, a plate 8 in this embodiment is comprised of two components, i.e. a first plate 8a and a second plate 8b which is placed on the first plate 8a. The first plate 8a includes holes 81a into which the ends 45A of the coil wire 45 are inserted and first groove portions 82a connected to the holes 81a and accommodating the coil wire 45. Further, the second plate 8b includes holes 81b into which the ends 45A of the coil wire 45 are inserted and which are communicated to the first groove portions 82a. Namely, the holes 81a of the first plate 8a and the holes 81b of the second plate 8b are offset relative to each other as seen in the rotational axis X direction.

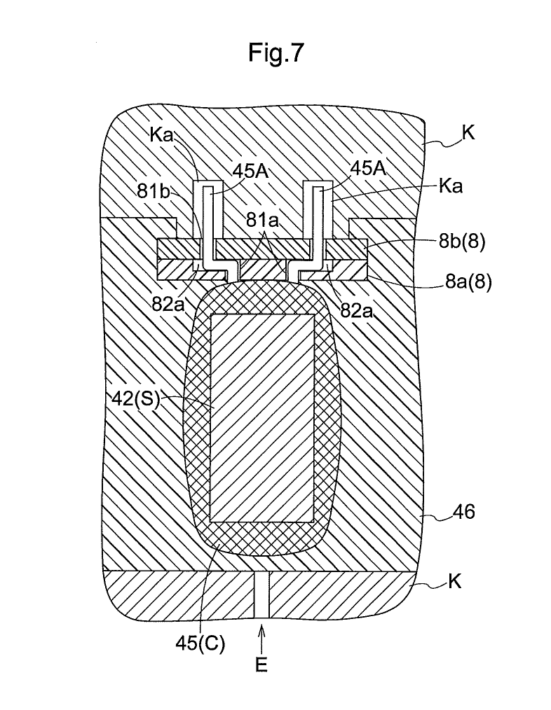

As shown in FIG. 7, a portion of an amount of resin introduced via the inlet E of the stator core S disposed opposite to the ends 45A of the coil wire 45 in the rotational axis X direction will flow into the holes 81a of the first plate 8a. This resin flown out of the holes 81a will then flow into the first groove portions 82a of the first plate 8a. In this, the flowing direction of the resin changes from the direction along the rotational axis X to a direction perpendicular to the rotational axis X. Thus, the resin will encounter pressure drop, which makes it difficult for the resin to reach the holes 81b of the second plate 8b.

As a result, leakage or discharge of injected resin from the holes 81b of the second plate 8b is prevented. Thus, the arrangement eliminates inconvenience of leaking of resin into the hole portions Ka of the mold K, generating burrs at the ends 45A of the coil wire 45. Therefore, even if the ends 45A of the coil wire 45 exposed from the resin portion 46 of the stator 4 are directly connected to the bus bars B, no deterioration will occur in the electric characteristics.

Incidentally, as the ends 45A of the coil wire 45 are drawn out of the offset holes 81b of the second plate 8b, the layout of the first groove portions 82a can be determined according to the positions for connection to the bus bars B. Namely, the arrangement of constituting the plate 8 of two parts provides greeter degree of freedom in setting of drawing out positons of the ends 45A of the coil wire 45.

### Further Embodiment 2

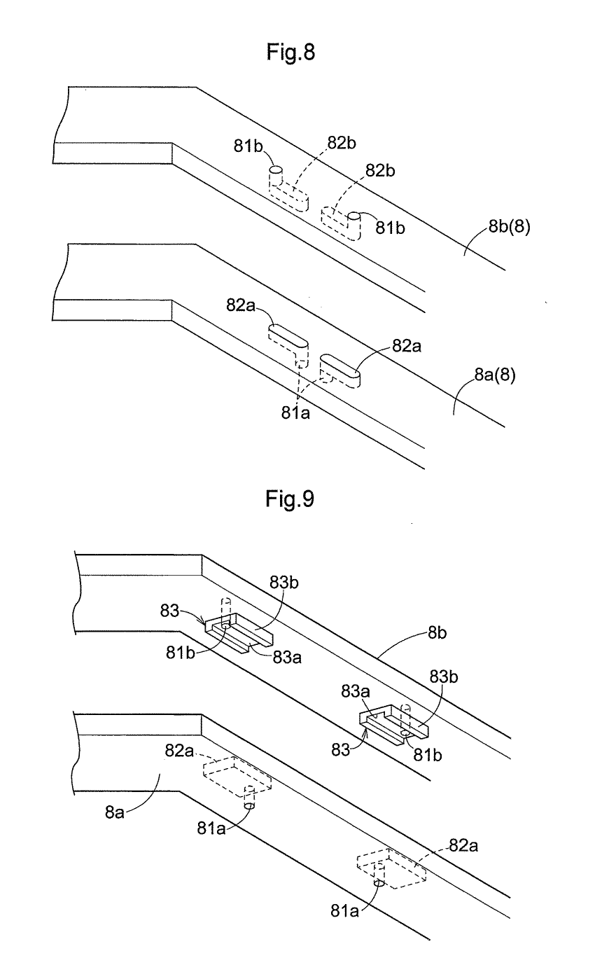

This embodiment differs from Further Embodiment 1 in the respect of the shape of the second plate 8b. As shown in FIG. 8, the second plate 8b defines second groove portions 82b which are in opposition to the first groove portions 82a of the first plate 8a and configured to accommodate the coil wire 45. Namely, the coil wire 45 will be accommodated in the first groove portions 82a and the second groove portions 82b as being sandwiched therebetween, and the holes 81a of the first plate 8a and the holes 81b of the second plate 8b are communicated to the first grove portions 82a and the second groove portions 82b.

With the above-described arrangement, in addition to the advantageous function/effect of Further Embodiment 1, as the positioning of the second plate 8b relative to the first plate 8a is effected with fitting the second groove portion 82b to the coil wire 45 exposed from the first groove portions 82a, attachment is facilitated.

### Further Embodiment 3

This embodiment differs from Further Embodiments 1 and 2 in the respect of the shape of the second plate 8b. As shown in FIG. 9, the second plate 8b includes protruding portions 83 which are to be inserted into the first groove portions 82a; the protruding portions 83 defining second groove portions 83a for accommodating the coil wire 45. More particularly, in the protruding portion 83, there are formed a pair of lateral walls 83b for sandwiching the coil wire 45, and between these lateral walls 83b, the second groove portion 83a is provided.

With the above-described embodiment, in addition to the advantageous function/effect of Further Embodiments 1 and 2, only by inserting the protruding portion 83 having the first groove portion 82a into the first groove portion 82a acting as an accommodation space for the coil wire 45, position fixing of the two members can be completed. Therefore, there is no need to provide the first plate 8a or the second plate 8b with e.g. a position fixing portion separately.

### Other Embodiments

(1) In the foregoing embodiments, the plate 8 is provided in the form of an integrated annular shape or a half-annular shape. However, the plate 8 may be formed independently for each split stator core S. In this case, the size of the plate 8 will be determined in accordance with an amount of withdrawal extension of the ends 45A of the coil wire 45. Thus, material for forming the plate 8 can be saved.

(2) The stator core S in the foregoing embodiment was described as a split core. Instead, this can be an integral core integrating the core portions 41. In this case, the core case 7 can be omitted and the insulator 44 encasing the core portion 41 can be formed to protrude in the rotational axis X direction, and the plate 8 can be placed in abutment against the inner circumferential face of this insulator 44.

(3) In the foregoing embodiment, the electric motor M is of the inner rotor type in which the rotor 3 is disposed on the inner side of the stator 4. Alternatively, it may be of an outer rotor type in which the rotor 3 is disposed on the outer side of the stator 4. In the case of such outer rotor type, the stator 4 will include an annular core portion 41 centered around the rotational axis X and a plurality of teeth portions 42 protruding radially outwards from the core portion 41. In this outer rotor type electric motor M too, the above-described function/effect can be expected to be obtained by providing the plate 8 to be placed on the stator core S along the rotational axis X.

(4) The machine in which the electric motor M in the foregoing embodiment is used is not limited to the water pump P for circulating cooling water for an engine, but may be a pump for circulating engine oil or even a machine for use in other applications than a vehicle. Further, the driving mode of the electric motor M is not limited to the three-phase brushless motor generating alternating magnetic field. Instead a brush motor may be employed.

### INDUSTRIAL APPLICABILITY

The stator according to the present invention is applicable to an electric motor for use in various machines such as a vehicle-mounted water pump.

### REFERENCE SIGNS LIST

3: rotor
4: stator
41: core portion
42: teeth portion
43: flange portion
45: coil wire
45A: end
46: resin portion
8: plate
81: hole
8a: first plate
81a: hole
82a: first groove portion
8b: second plate
81b: hole
82b: second groove portion
83: protruding portion
83a: second groove portion
B: bus bar
S: stator core
X: rotational axis

1. A stator comprising:
a stator core including an annular core portion centered around a rotational axis of a rotor and a plurality of teeth portions protruding radially from the core portion;
a core wire wound around the teeth portions;
a resin plate to be superposed on the stator core along the rotational axis, the resin plate defining a hole therethrough along the rotational axis, into which hole an end portion of the coil wire is inserted; and
a resin portion in which the stator core, the coil wire and the plate are embedded;
wherein the end of the coil wire is directly connected to a bus bar for electric power supply or grounding, with the end of the coil wire being exposed from the resin portion.

2. The stator according to claim 1, wherein:
the plate includes a first plate and a second plate placed on the first plate;
the first plate defines a first groove portion configured to be connected to the hole of the first plate and to accommodate the coil wire; and
the hole of the second plate is communicated to the first groove portion.

3. The stator according to claim 2, wherein the second plate defines a second groove portion which is formed in opposition to the first groove portion and configured to accommodate the coil wire.

4. The stator according to claim 2, wherein the second plate includes a protruding portion which is inserted into the first groove portion, the protruding portion defining a second groove portion for accommodating the coil wire.
